(19) United States
(12) Patent Application Publication
(10) Pub. No.: US 2010/0106573 A1
(43) Pub. Date: Apr. 29, 2010

(54) ACTION SUGGESTIONS BASED ON INFERRED SOCIAL RELATIONSHIPS

(76) Inventors: Andrew C. Gallagher, Fairport, NY (US); Jiebo Luo, Pittsford, NY (US)

Correspondence Address: EASTMAN KODAK COMPANY;PATENT LEGAL STAFF, 343 STATE STREET, ROCHESTER, NY, 14650-2201, US

(21) Appl. No.: 12/258,390

(22) Filed: Oct. 25, 2008

(51) Int. Cl. G06Q 30/00; G06Q 90/00

(52) U.S. Cl. 705/14.4; 705/319

(57) ABSTRACT

A method of categorizing a social relationship between individuals in a collection of images to suggest a possible course of action, includes searching the collection to identify individuals and determining their genders and their age ranges; using the gender, and age ranges of the identifies individuals to infer at least one social relationship between them; and using at least one inferred social relationship to suggest a possible course of action.

### CROSS REFERENCE TO RELATED APPLICATION

Reference is made to commonly assigned U.S. patent application Ser. No. 12/020,141 filed Jan. 25, 2008, entitled “Discovering Social Relationships From Personal Photos” by Jiebo Luo et al, the disclosure of which is incorporated herein.

### FIELD OF THE INVENTION

The present invention is related to inferring social relationships from personal image collections and suggesting a course of action.

### BACKGROUND OF THE INVENTION

Consumer image collections are all pervasive. Mining semantically meaningful information from such collections has been an area of active research in machine learning and computer vision communities. There is a large body of work focusing on problems of object recognition, detecting objects of certain types such as faces, cars, grass, water, sky, and so on. Most of this work relies on using low level vision features (such as color, texture and lines) available in the image. In the recent years, there has been an increasing focus on extracting semantically more complex information such as scene detection and activity recognition. For example, one might want to cluster pictures based on if they were taken outdoors or indoors, or separate work pictures from leisure pictures. Solution to such problems primarily relies on using the derived features such as people present in the image, presence or absence of certain kinds of objects in the image and so on. Typically, power of collective inference is used in such scenarios. For example, it can be difficult to tell for a particular picture if it is work or leisure, but looking at other pictures which are similar in location and time, it might become easier to make the same prediction. This line of research aims to revolutionize the way people perceive the digital image collection—from a bunch of pixel values to highly complex and meaningful objects which can be queried for information or automatically organized in ways which are meaningful to the user.

Taking semantic understanding a step further, humans have the ability to infer the relationships between people appearing in the same picture after observing a sufficient number of pictures: are they families members, friends, just acquaintances, or merely strangers who happen to be in the same place at the same time. In other words, consumer photos are usually not taken in coincidence with strangers but often with friends and families. Detecting or predicting such relationships can be an important step towards building intelligent cameras as well as intelligent image management systems.

It is known to analyze images to detect people and the ages and gender of detected people can be surmised. Furthermore, several systems provide advertisement suggestions based on demographic information. For example, in U.S. Pat. No. 7,362,919, images are arranges on themed album pages, where graphical elements are based on the ages and genders of the persons in the images. Likewise in U.S. Pat. No. 7,174,029, a video camera is used to monitor an environment, detect people, determine a person's demographic profile, and serve the person an advertisement based on the demographic profile. While these methods are useful for advertising that appeal to a single person, they are not effective for advertising products that related not to a single person, but to the social relationship shared between multiple people.

### SUMMARY OF THE INVENTION

In accordance with the present invention, there is provided a method of categorizing a social relationship between individuals in a collection of images to suggest a possible course of action, comprising:

(a) searching the collection to identify individuals and determining their genders and their age ranges;

(b) using the gender, and age ranges of the identifies individuals to infer at least one social relationship between them; and

(c) using at least one inferred social relationship to suggest a possible course of action.

Features and advantages of the present invention include using a collection of personal images associated with the personal identity, age, and gender information to automatically discover the type of social relationships between the individuals appearing in the personal images and therefore permitting a system to suggest possible courses of action such as product suggestions, activities, sharing opportunities, or social network links.

### BRIEF DESCRIPTION OF THE DRAWINGS

FIG. 1 is pictorial of a system that can make use of the present invention;

FIG. 2 is a flow chart for practicing an embodiment of the invention;

FIG. 3 is a table showing the ontological structure of social relationship types;

FIGS. 4a and 4b depict examples of images and the corresponding social relationships inferred from the images;

FIG. 5 illustrates a system for using social relationships found in a image collection for creating a family tree, searching for images in the image collection, and providing suggestions to a user;

FIG. 6 provides an example image collection and discovered social relationships;

FIG. 7 illustrates a family tree; and

FIG. 8 illustrates a suggested product based on a social relationship.

### DETAILED DESCRIPTION OF THE INVENTION

The present invention is a way to automatically detect social relationships in consumer image collections. For example, given two faces appearing in an image, one would like to be able to infer they are spouse of each other as opposed to simply being friends. Even in the presence of additional information about age, gender and identity of various faces, this task seems extremely difficult. What information can a picture have in order to distinguish between a “friends” or a “spouse” relationship? But when a group of related pictures is looked at collectively, this task becomes more tractable. In particular, a third party person (other than the subject in the picture and the photographer) can have a good guess for an above task based on the rules of thumb such as: a) couples often tend to be photographed just by themselves as opposed to friends who typically appear in groups, and b) couples with young children often appear with their children in the photos. The advantage of the approach is that one can even say meaningful things about relationships between people who never (or very rarely) are photographed together in a given collection. For example, if A (male) appears with a child in bunch of photos and B (female) appears with the same child in other photos, and A and B appear together in a few other photos, then most likely they share spouse relationship and are the parents of the child being photographed with them.

The present invention captures the rules of thumb as described above in a meaningful way. There are a few key issues that need to be taken into account when establishing such rules:

(a) these are rules of thumb after all and thus cannot always be correct.

(b) many rules can fire at the same time and they need to be carefully combined.

(c) multiple rules can conflict with each other in certain scenarios.

A good method to handle these issues is Markov Logic (Markov Logic Networks”; by M. Richardson and P. Domingos, Machine Learning, 62:107-136, pp. 1-43, Jan. 26, 2006.6) which provides a framework to combine first order logic rules in a mathematically sound way. Each rule is seen as a soft constraint (as opposed to a hard constraint in logic) whose importance is determined by the real valued weight associated with it. Higher the weight is, the more important the rule is. In other words, given two conflicting rules, the rule with higher weight should be believed with the greater confidence, other things being equal. Weights can be learned from training data. Further, Markov logic also provides the power to learn new rules using the data, in addition to the rules supplied by the domain experts, thereby enhancing the background knowledge. These learned rules (and their weights) are then used to perform a collective inference over the set of possible relationships. As will be described later, one can also a build a collective model over predicting relationships, age and gender, using noisy predictors (for age and gender) as inputs to the system. Predicting one component helps predict the other and vice-versa. For example, recognizing that two people are of same gender helps eliminate the spouse relationship and vice-versa. Inference done over one picture is carried over to other pictures, thereby improving the overall accuracy.

Statistical relational models combine the power of relational languages such as first order logic and probabilistic models such as Markov networks. This provides the capability to explicitly model the relations in the domain (for example various social relationship in our case) and also explicitly take uncertainty (for example, rules of thumb cannot always be correct) into account. There has been a large body of research in this area in the recent years. One of the most powerful such model is Markov logic (Markov Logic Networks”; by M. Richardson and P. Domingos, Machine Learning, 62:107-136, pp. 1-43, Jan. 26, 2006.). It combines the power of first order logic with Markov networks to define a distribution over the properties of underlying objects (e.g. age, gender, facial features in our domain) and relations (e.g. various social relationships in our domain) among them. This is achieved by a attaching a real valued weight to each formula in a first order theory, where the weight (roughly) represents the importance of the formula. Formally, a Markov Logic Network L is defined as a set of pairs (Fi,wi), Fi being a formula in first order logic and wi a real number. Given a set of constants C, the probability of a particular configuration x of the set of ground predicates X is given as

$$P ( X = x ) = \frac{1}{Z} exp ( {\sum }_{i = 1}^{m} {w}_{i} {n}_{i} ( x ) )$$

where the sum is over all the formulas appearing in L, wi is the weight of the ith formula and ni(x) is the number of its true groundings under the assignment x. Z is the normalization constant. For further details, see the above cited Richardson & Domingos.

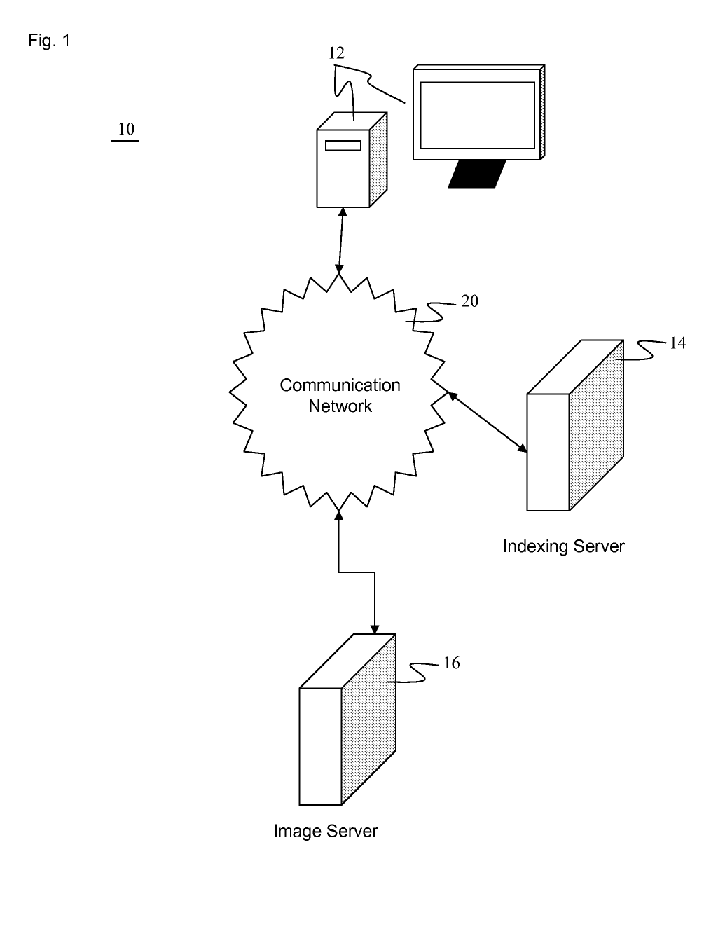

In FIG. 1, system 10 is shown with the elements necessary to practice the current invention including a computing device 12, an indexing server 14, an image server 16, and a communications network 20. Computing device 12 can be a personal computer for storing images where images will be understood to include both still and moving or video images. Computing device 12 communicates with a variety of devices such as digital cameras or cell phone cameras (not shown) for the purpose of storing images captured by these devices. These captured images can further include personal identity information such as names of the persons in the image by the capturing device (by either voice annotation or in-camera tagging). Computing device 12 can also communicate through communications network 20 to an internet service that uses images captured without identity information and permits the user or a trained automatic algorithm to add personal identity information to the images. In either case, images with personal identity information are well known in the art.

Indexing server 14 is another computer processing device available on communications network 20 for the purposes of executing the algorithms in the form of computer instructions that analyze the content of images for semantic information such as personal identity, age and gender, and social relationships. It will be understood that providing this functionality in system 10 as a web service via indexing server 12 is not a limitation of the invention. Computing device 12 can also be configured to execute the algorithms responsible for the analysis of images provided for indexing.

Image server 16 communicates with other computing devices via communications network 20 and upon request, image server 16 provides a snapshot photographic image that can contain no person, one person or a number of persons. Photographic images stored on image server 16 are captured by a variety of devices, including digital cameras and cell phones with built-in cameras. Such images can also already contain personal identity information obtained either at or after the original capture manually or automatically.

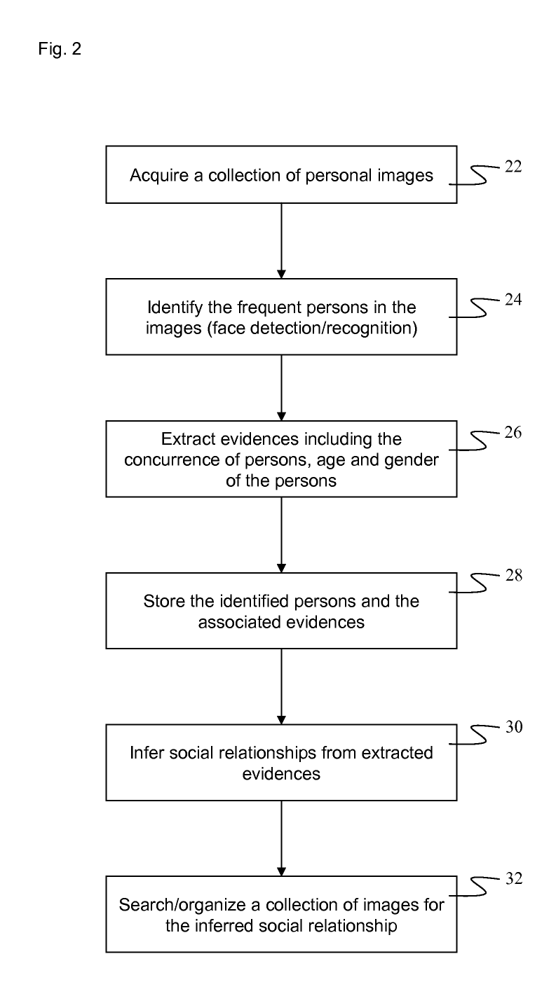

In FIG. 2, a process diagram is illustrated showing the sequence of steps necessary to practice the invention. In step 22, a collection of personal images is acquired that contain a plurality of persons potentially related socially. The personal identity information is preferably associated with the image in the form of metadata, but can be merely supplied in association with the image without deviating from the scope of the invention. The image can be provided by computing device 12 from its internal storage or from any storage device or system accessible by computing device 12 such as a local network storage device or an online image storage site. If personal identity information is not available, using the collection of images provided in step 22, computing device 12 provides the personal identity information to indexing server 14 in step 24 to acquire personal identity information associated each of the images, either through automatic face detection and face recognition, or manual annotation.

Using the acquired photographic image of step 24, computing device 12 extracts evidences including the concurrence of persons, age and gender of the persons in each image in step 26 using classifiers in the following manner. Facial age classifiers are well known in the field, for example A. Lanitis, C. Taylor, and T. Cootes, “Toward automatic simulation of aging effects on face images,” PAMI Vol. 14, No. 4, 2002 and X. Geng, Z.-H. Zhou, Y. Zhang, G. Li, and H. Dai, “Learning from facial aging patterns for automatic age estimation,” in ACM MULTIMEDIA, 2006 and A. Gallagher in U.S. Patent Application Publication No. 2006/0045352. Gender can also be estimated from a facial image, as described in M.-H. Yang and B. Moghaddam, “Support vector machines for visual gender classification,” Proc. ICPR, 2000 and S. Baluja and H. Rowley, “Boosting sex identification performance,” in IJCV 71(2), 2007.

For age classification, the image collections from three consumers are acquired, and the individuals in each image are labeled, for a total of 117 unique individuals. The birth year of each individual is known or estimated by the collection owner. Using the image capture date from the EXIF information and the individual birthdates, the age of each person in each image is computed. This results in an independent training set of 2855 faces with corresponding ground truth ages. Each face is normalized in scale (49×61 pixels) and projected onto a set of Fisherfaces (as described by P. N. Belhumeur, J. Hespanha, and D. J. Kriegman. Eigenfaces vs. fisherfaces: Recognition using class specific linear projection. PAMI Vol. 19, No. 7, 1997.) The age estimate for a new query face is found by normalizing its scale, projecting onto the set of Fisherfaces, and finding the nearest neighbors (the present invention uses 25) in the projection space. The estimated age of the query face is the median of the ages of these nearest neighbors. For estimating gender, a face gender classifier using a support vector machine is implemented. In the present invention, the feature is reduced dimensionality by first extracting facial features using an Active Shape Model (T. Cootes, C. Taylor, D. Cooper, and J. Graham. Active shape models-their training and application. CVIU Vol. 61, No. 1, 1995.) A training set of 3546 faces, again from our consumer image database, is used to learn a support vector machine which outputs probabilistic density estimates.

The identified persons and the associated evidences are then stored in step 28 for each image in the collection in preparation for the inference task. The computing device 12 or the indexing server 12 can perform the inference task depending on the scale of the task. In step 30, the social relationships associated with the persons found in the personal image collection is inferred from the extracted evidences. Finally, having inferred the social relationship of the persons in a personal image collection permits computing device 12 to organize or search the collection of images for the inferred social relationship in step 32. It would be obvious to those skilled in the art that such a process can be executed in an incremental manner such that new images, new individuals, and new relationships can be properly handled. Furthermore, this process can be used to track of the evolution of individuals in terms of changing appearances and social relationships in terms of expansion, e.g., new family members and new friends.

In a preferred embodiment of the present invention, in step 30, the model, i.e., the collection of social relationship rules predictable from personal image collections is expressed in Markov logic. The following describes the concerned objects of interest, predicates (properties of objects and the relationships among them), and the rules which impose certain constraints over those predicates. Later on, descriptions are provided for the learning and inference tasks.

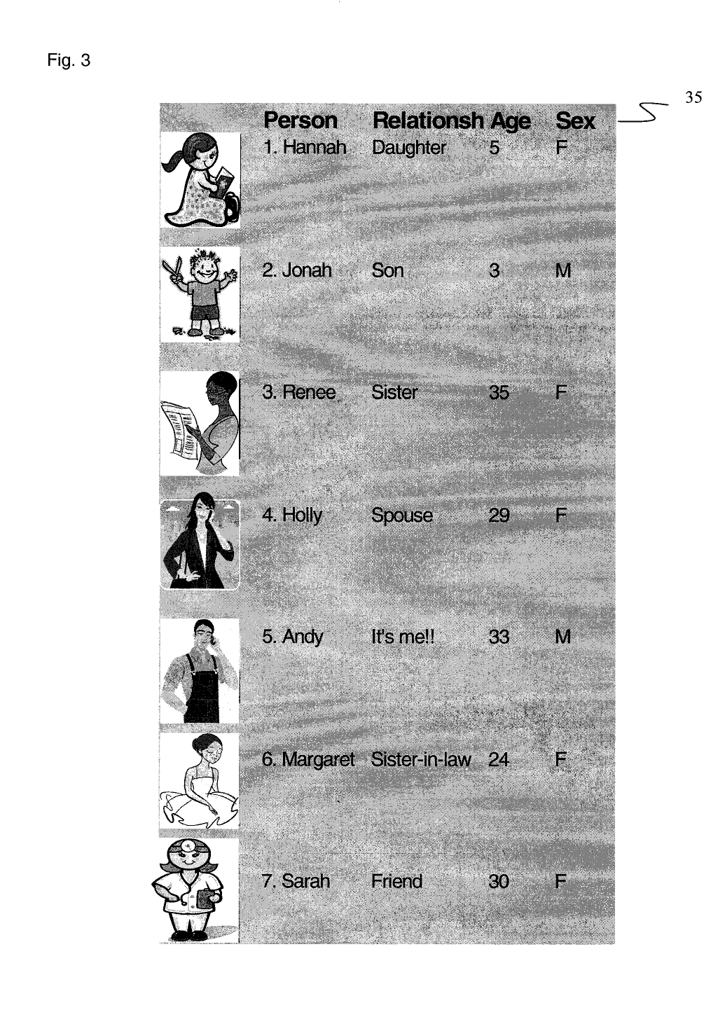

FIG. 3 is a table showing the ontological structure 35 of social relationship types (relative to the owner of the personal image collection). More arbitrary relationships between arbitrary individuals can be defined without deviating from the essence of the present invention.

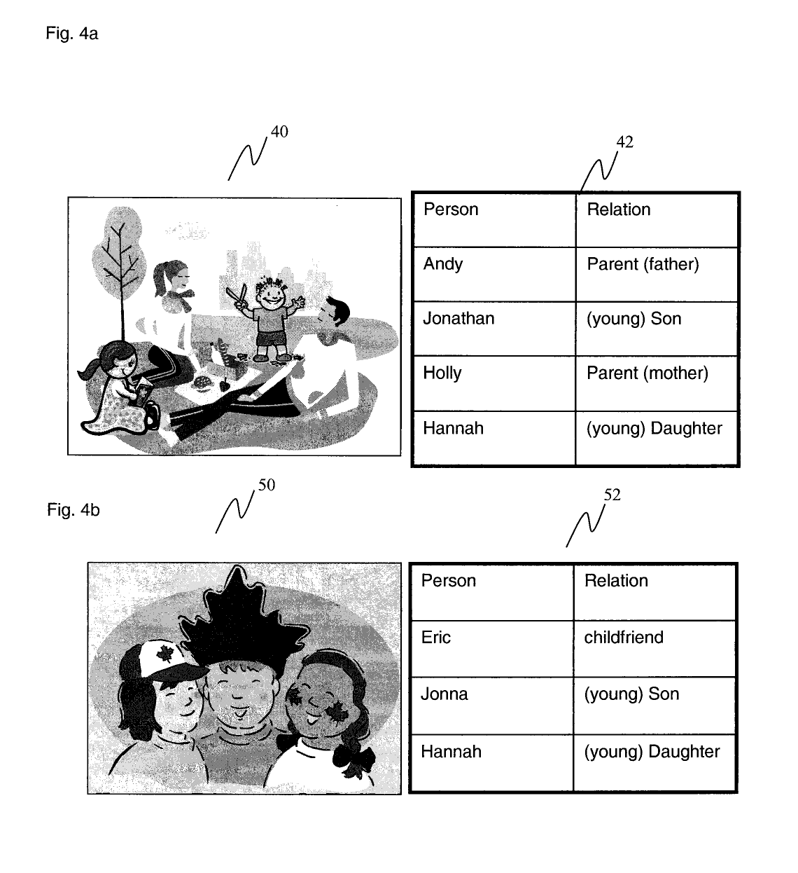

FIGS. 4a and 4b depict examples of personal photographic images (40 and 50) and the corresponding social relationships (42 and 52) inferred from the images.

The following provides more details on the preferred embodiment of the present invention. There are three kinds of objects in the domain of the present invention:

Person: A real person in the world.

Face: A specific appearance of a face in an image.

Image: An image in the collection.

Two kinds of predicates are defined over the objects of interest. The value of these predicates is known at the time of the inference through the data. An example evidence predicate would be, OccursIn(face,img) which describes the truth value of whether a particular face appears in a given image or not. The present invention uses the evidence predicates for the following properties/relations:

Number of people in an image: HasCount(img,cnt)

The age of a face appearing in an image: HasAge(face,age)

The gender of a face appearing in an image: HasGender(face, gender)

Whether a particular face appears in an image: OccursIn(face, img)

Correspondence between a person and his/her face: HasFace(person, face)

The age (gender) of a face is the estimated age (gender) value associated with a face appearing in an image. This is different from the actual age (gender) of a person which is modeled as a query predicate. The age (gender) associated with a face is inferred from a model trained separately on a collection of faces using various facial features as previously described Note that different faces associated with the same person can have different age/gender values, because of estimation errors due to difference in appearances, or the time difference in when the pictures were taken. The present invention, models the age using 5 discrete bins: child, teen, youth, middle-aged and senior.

In the present invention application, it is assumed that face detection and face recognition have been done before hand by either automatically or manually. Therefore, it is known exactly which face corresponds to which person. Relaxing this assumption and folding algorithmic face detection and face recognition as part of the model is a natural extension that can be handled properly by the same Markov logic-based model and the associated inference method.

The value of these predicates is not known at the time of the inference and needs to be inferred. Example of this kind of predicates is, HasRelation(person1, person2, relation) which describes the truth value of whether two persons share a given relationship. The following query predicates are used:

Age of a person: HasAge(person, age)

Gender of a person: HasGender(person, gender)

The relationship between two persons: HasRelation(person1, person2, relation)

A preferred embodiment of the present invention models seven different kind of social relationships: relative, friend, acquaintance, child, parent, spouse, childfriend. Relative includes any blood relatives not covered by parents/child relationship. Friends are people who are not blood relatives and satisfy the intuitive definition of friendship relation. Any non-relatives, non-friends are modeled as acquaintances. Childfriend models the friends of children. It is important to model the childfriend relationship, as the children are pervasive in consumer image collections and often appear with their friends. In such scenarios, it becomes important to distinguish between children and their friends.

There are two kinds of rules: hard rules and soft rules. All the rules are expressed as formulas in first order logic.

Hard rules describe the hard constraints in the domain, i.e., they should always hold true. An example of a hard rule is OccursIn(face, img1) and OccursIn(face, img2)→(img1=img2), which is simply stating that each face occurs in at most one image in the collection.

Parents are older than their children.

Spouses have opposite gender.

Two people share a unique relationship among them.

Note that in the present invention there is a unique relationship between two people. Relaxing this assumption (e.g. two people can be relatives (say cousins) as well friends) can be an extension of the current model.

Soft rules describe the more interesting set of constraints—we believe them to be true most of the times but they cannot always hold. An example of a soft rule is OccursIn(person1, img) and OccursIn(person2, img)→!HasRelation(person1, person2, acquaintance). This rule states that two people who occur together in a picture are less likely to be mere acquaintances. Each additional instance of their occurring together (in different pictures) further decreases this likelihood. Here are some of the other soft rules used in the present invention:
Children and their friends are of similar age.
A young adult occurring solely with a child shares the parent/child relationship.
Two people of similar age and opposite gender appearing together (by themselves) share spouse relationship.
Friends and relatives are clustered across photos: if two friends appear together a photo, then a third person occurring in the same photo is more likely to be a friend. Same holds for relatives.

In general, one would prefer a solution which would satisfy all the hard constraints (presumably such a solution always exists) at the same time, satisfying the most number (weighted) of soft constraints.

Finally, there is a rule consisting of a singleton predicate HasRelation(person1,person2,+relation) (+means that we learn a different weight for each relation) which can be thought of representing the prior probability of a particular relationship holding between any two random people in the collection. For example, it would be much more likely to have a friends relationship as compared to the parents or child relationship. Similarly, there are the singleton rules HasAge(person, +age and HasGender(person, +gender). These represent (intuitively) the prior probabilities of having a particular age and gender, respectively. For example, it is easy to capture the fact that children tend to be photographed more often by giving a high weight to the rule HasAge(person, child).

Given the model (the rules and their weights), inference corresponds to finding the marginal probability of query predicates HasRelation, HasGender and HasAge given all the evidence predicates. Because of the need to handle a combination of hard (deterministic) and soft constraints, the MC-SAT algorithm of Poon & Domingos (see Poon & Domingos, Sound and efficient with probabilistic and deterministic dependencies. Proceedings of AAAI-06, 458-463. Boston, Mass.: AAAI Press.) is used in a preferred embodiment of the present invention.

Given the hard and soft constraints, learning corresponds to finding the optimal weights for each of the soft constraints. First, the MAP weights are set with a Gaussian prior centered at zero. Next, the learner of Lowd & Domingos is employed (Lowd & Domingos. Efficient weight learning for Markov logic networks. In Proc. PKDD-07, 200-211. Warsaw, Poland: Springer.). The structure learning algorithm of Kok & Domingos is used (Kok & Domingos, Learning the structure of Markov logic networks. Proceedings of. ICML-05, 441-448. Bonn, Germany: ACM Press.) to refine (and learn new instances) of the rules which help predict the target relationships. The original algorithm as described by them does not permit the discovery of partially grounded clauses. This is important for the present invention as there is a need to learn the different rules for different relationships. The rules can also differ for specific age groups (such as children) or gender (for example, one can imagine that males and females differ in terms of whom they tend to be photographed in their social circles). The change needed in the algorithm to have this feature is straightforward: the addition of all possible partial groundings of a predicate is permitted during the search for the extensions of a clause. Only certain variables (i.e. relationship, age and gender) are permitted to be grounded in these predicates to avoid blowing up the search space. The rest of the algorithm proceeds as before.

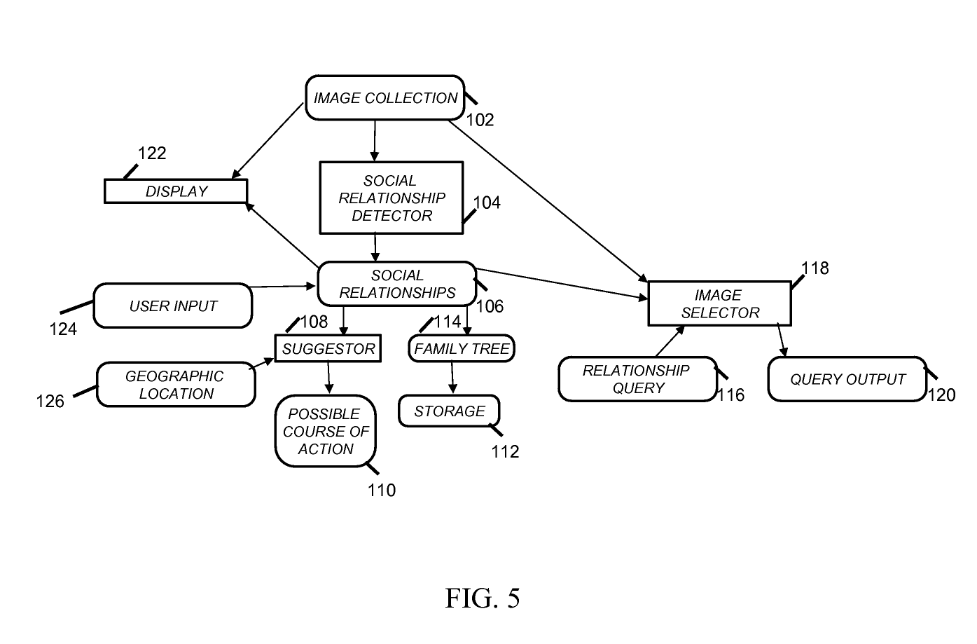

FIG. 5 illustrates a system that uses the inferred social relationships for making suggestions of courses of action 110 to the owner of the image collection, a viewer of the image collection, or another person or party. The system suggests a product advertisement, suggest a product, suggest an activity, suggest a sharing opportunity, or suggest a link in an online social network based on the determined social relationships. Furthermore, the system is used to search an image collection based on social relationships and also used to produce a family tree.

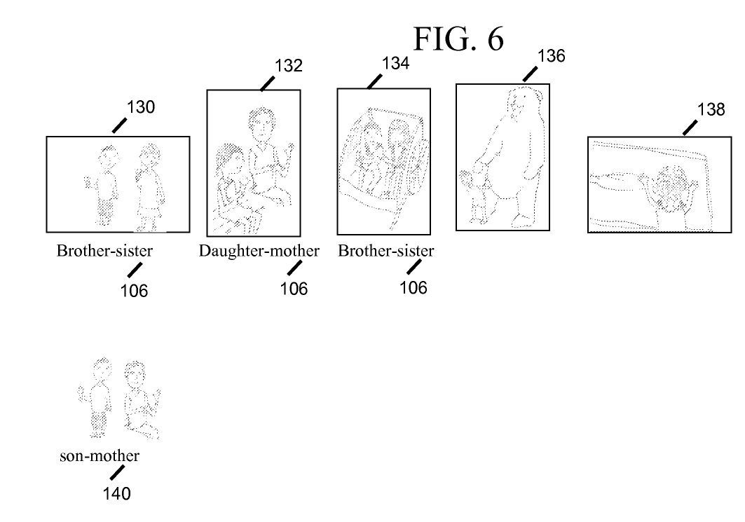

With reference to FIG. 5, a image collection 102 is input to a social relationship detector 104. The image collection 102 contains digital images and videos. The social relationship detector 104 detects faces of individuals and other features in the image collection and detects social relationships 106 such as for example mother-child, husband-wife, father-son, friends, grandfather-granddaughter. One embodiment of the social relationship detector 104 is described in FIG. 2 and the accompanying description hereinabove. The features used to determine social relationship include faces, detected ages and genders, relative pose of people (the juxtaposition of people within an image). When faces are detected in more than one image, face recognition is used to determine the likelihood that the faces are the same individual, as described for example in M. Turk and A. Pentland, “Eigenfaces for Recognition”, Journal of Cognitive Neuroscience, vol. 3, no. 1, pp. 71-86, 1991. The discovered social relationship 106 can be the social relationship between two people appearing in a single image or video, two people appearing in different images, or between the photographer or collection owner and a person in an image or video. The social relationship 106 can also be found for a group of 3 or more people, for example a family or a group of friends. FIG. 6 shows an example image collection 102 with five images (130, 132, 134, 136, and 138) and an example of the social relationships 106 found. Three images contain two people, and the social relationships 106 brother-sister and daughter-mother are found. By recognizing that the girl in images 130, 132 and 134 are the same individual and using the transitive property of social relationships (e.g. a boy's sister's mother is also the boy's mother), the son-mother social relationship 140 is discovered, even though the son and mother never appear together in an image in the image collection.

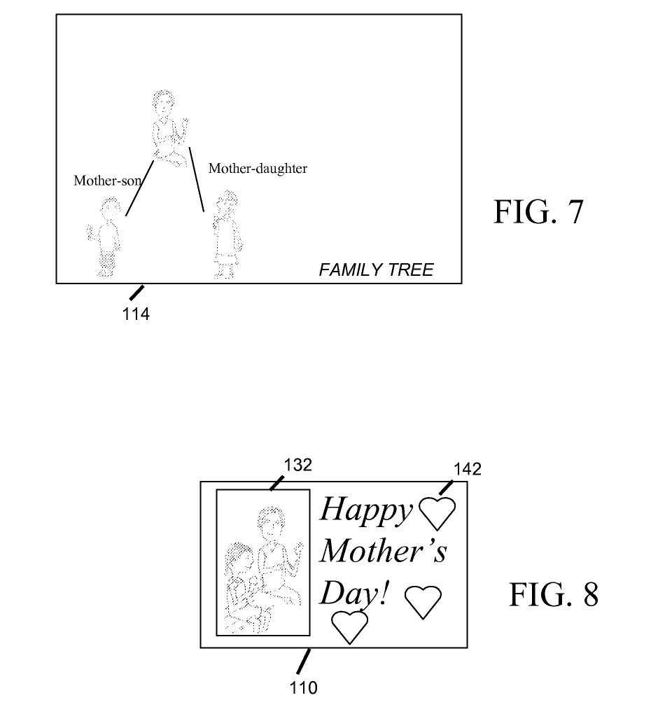

Referring back to FIG. 5, a family tree 114 is constructed from the social relationships 106 by using the commonly known notation that marriages (parents) form nodes on the tree and children are branches. FIG. 7 illustrates an example family tree 114 along with the likenesses of the individuals, based on the discovered social relationships 106. The family tree is stored in digital storage 112, such as an image or as a XML schema.

Referring again to FIG. 5, a display 122 such as an LCD screen is used to display the images from the image collection 102 to a user along with the social relationship 106 from the social relationship detector 104. The user can supply user input 124 to correct mistakes (e.g. detected social relationships that are not accurate, or mistakes resulting from errors in face recognition) or provide missing social relationships.

The social relationships 106 are input to the suggestor 108, to make suggestions of possible courses of action 110 based on the social relationships 106. The suggestions of possible courses of action 110 are related to product advertisements, image product suggestions, activity suggestions, sharing opportunity suggestions, or social network suggestions. The possible courses of action are intended for a user who is either the collection owner or for a person other than the collection owner (e.g. a person who is viewing the image collection, or a friend or relative) or another party, for example a company that sells a product that has as a target demographic certain social relationships. The suggestor 108 optionally considers the geographic location 126 of the user or the geographic location of images from the image collection 102.

The possible course of action 110 is displayed to the user preferably via a display, though the suggestion can be sent in another form such as an email, fax, instant message, letter or telephone call. A product advertisement is an advertisement for an existing product that can be purchased that does not incorporate an image from the consumer. When the suggestion is a product advertisement, the product advertisement is selected from a database of possible product advertisements based on the social relationship. For example, a product advertisement for a children's board game is selected and displayed to the collection owner, user, or viewer when an image collection contains a pair of young siblings. This advertisement possible course of action 110 is useful for the user because it provides a gift giving idea (e.g. for an aunt viewing the image collection to buy for nieces and nephews for Christmas). The suggestor 108 considers other demographic information about the social relationship when selecting the advertisement. The ages and genders of the people in the social relationship can be relevant. For example, an advertisement possible course of action 110 of a doll game might be selected for younger siblings, and an advertisement possible course of action 110 of an advanced strategy game might be selected for older teenagers. The advertisement possible course of action 110 for a mother and child social relationship 106 is a minivan with a high safety rating. The advertisement possible course of action 110 for a mother and father and son and daughter is a house with the correct number of bedrooms to accommodate the family.

Another possible course of action 110 is to suggest a potential customer. In this scenario, based on the social relationships within an image collection, the system determines potential customers for a particular product. For example, based on detecting the social relationships from images and videos from a particular image collection, the potential customers for a minivan product are determined to be the parents of several small children. Information about the potential customer can be sold to a product advertiser. When many image collections are examined, many potential customers are found for each of many products. Lists of potential customers and their contact information are sold to product advertisers. The product advertisers then send a product advertisement to one or more potential customers.

An image product possible course of action 110 is a suggested product that incorporates at least one image or video from the image collection 102 to the image collection owner or an image collection viewer. For example, shown in FIG. 8 is a product possible course of action 110 of a Mother's Day Card is created from an image 132 of a mother and daughter that is suggested to a user to purchase for Mother's day. The graphics 142 on the card are selected in accordance with the social relationship 106. The product suggestion is created with a specific holiday in mind and depends also on the calendar time (i.e. a Mother's Day card should be suggested only in the weeks leading up to Mother's Day). The suggestion also depends on the identity of the user. The Mother's Day card is suggested to a user (an image collection viewer) who is not the intended recipient of the gift, but rather is either the husband or child of the woman. Other relationship holidays are Valentine's Day, Sweetheart Day, Grandparent's Day, and Father's Day and personal anniversaries (wedding or otherwise). Product suggestions are not limited to physical objects and include slide shows of images and videos from the image collection 102 set to music where the music is selected in accordance with the social relationship 106, frames where the frame includes an image from the image collection 102 and the frame contains a graphic 142 or motif related to the social relationship.

An activity possible course of action 110 is a suggestion of an activity that the persons sharing the social relationship might enjoy. In the preferred embodiment, the activity possible course of action 110 is produces in accordance with the geographic location of the user. For example, an activity possible course of action 110 for a image collection containing a father-daughter relationship is “Father-Daughter bowling day is May 2 at Rolling Lanes in Brockport, N.Y.” when the user lives near Brockport N.Y. The suggestor 108 optionally considers the preferences that the individuals in the relationship have (e.g. a wife might enjoy both camping and bowling, but the husband might only enjoy bowling, so the suggestor 108 would suggest “Couple Bowling Night” rather than a “Couple's Camp-out.” The activity that is suggested is related to a sport (e.g. soccer, basketball either as participants or viewers) a heath event (e.g. a marriage workshop, or a seminar for adults with elderly parents) or a hobby (e.g. camping, watching movies, woodworking, or gardening).

The suggestor 108 also provides sharing suggestions as a possible course of action 110 based on the social relationships 106 in the image collection 102. A sharing suggestion is a possible course of action 110 to share one or more of the image collection 102 images with a particular individuals. For example, a sharing suggestion to share the images of siblings with the Flickr Photo Sharing website group “Siblings” (http://www.flickr.com/groups/siblings/) is provided.

The suggestor 108 also provides social network suggestions as a possible course of action 110 based on the social relationships 106 in the image collection 102. A social network suggestion is a suggestion of a social network link (e.g. on www.facebook.com) based on a detected social connection. For example, if in a image collection 102 it is found by the social relationship detector 104 that Mary and Frank are friends, then the possible course of action 110 is made to either:

Mary to request a connection with Frank

Frank to request a connection with Mary

Or both of the above.

Referring again to FIG. 5, the social relationships 106 are used for searching or browsing the image collection 102. A relationship query (e.g. “mother-son” 116 is posed to the image selector 118. The image selector 118 provides query output 120 including the images and videos containing the queried social relationship. The relationship query 116 can also be in the form of an image, e.g. the image 132 in FIG. 6 is posed as a relationship query 116 to retrieve as the query output 120 all of the images that contain a mother and daughter.

In all cases, the suggestor's 108 behavior evolves over time based on applicable data. For example, possible courses of action 110 that are product advertisement suggestions based on social relationships are selected based on items that sell particularly well to persons that share a particular social relationship. The set of these products can vary with the time of day, time of year, or as time progresses, and also vary with the geographic location.

The invention has been described in detail with particular reference to certain preferred embodiments thereof, but it will be understood that variations and modifications can be effected within the spirit and scope of the invention.

### PARTS LIST

10 current system
12 computing device
14 indexing server
16 image server
20 communications network
22 acquiring a collection of personal images
24 identifying the frequent persons in the images (face detection/recognition)
26 Extracting evidences including the concurrence of persons, age and gender of the persons
28 Storing the identified persons and the associated evidences
30 Inferring the social relationships associated with the persons from extracted evidences
32 Search/organize a collection of images for the inferred social relationship
35 ontological structure of social relationship types
40 example image
42 example relationships
50 example image
52 example relationships
102 image collection
104 social relationship detector
106 social relationships
108 suggestor
110 possible course of action
112 storage
114 family tree
116 relationship query
118 image selector
120 query output
122 display
124 user input
126 geographic location
130 image of a brother and sister
132 image of a daughter and mother
134 image of a brother and sister
136 image
138 image
140 son-mother social relationship
142 graphic based on social relationship

1. A method of categorizing a social relationship between individuals in a collection of images to suggest a possible course of action, comprising:
(a) searching the collection to identify individuals and determining their genders and their age ranges;
(b) using the gender, and age ranges of the identifies individuals to infer at least one social relationship between them; and
(c) using at least one inferred social relationship to suggest a possible course of action.

2. The method of claim 1, wherein the possible courses of action include suggesting a product advertisement, a potential customer for particular product(s), an image product, an activity, a sharing opportunity, or a link in an online social network.

3. The method of claim 2, wherein the product advertisement is provided to the collection owner, and the product in the advertisement is related to a specific holiday.

4. The method of claim 1, wherein the possible course of action is suggested to a person other than the collection owner.

5. The method of claim 2, wherein the image product incorporates an image from the image collection from which the inferred social relationship is found.

6. The method of claim 2, wherein the activity comprises an educational activity, a sports related activity, a hobby related activity, or a health or medical related activity.

7. The method of claim 1, wherein the geographic location of the collection owner is used to suggest the course of action.

8. A method of producing a family tree from a collection of images, comprising:
(a) searching the collection to identify individuals and determining their genders and their age ranges;
(b) using the gender, and age ranges of the identifies individuals to infer at least two social relationships between individuals;
(c) producing a family tree using at least two inferred social relationships; and
(d) storing the family tree so that it can be associated with the collection.

9. The method of claim 8, further comprising searching an image collection based on the family tree.

10. A method of categorizing a social relationship between individuals in a collection of images to search an image collection, comprising:
(a) searching the collection to identify individuals and determining their genders and their age ranges;
(b) using the gender, and age ranges of the identifies individuals to infer at least one social relationship between individuals; and
(c) searching an image collection based on the inferred social relationship.
